(19) United States
(12) Patent Application Publication
(10) Pub. No.: US 2006/0157676 A1
(43) Pub. Date: Jul. 20, 2006

(54) Ionic or ion-generating floor covering and method for embedding ion particles within a floor covering

(75) Inventor: Chen-chi Mao, Taipei (CN)

Correspondence Address: DUANE MORRIS LLP;IP DEPARTMENT, 30 SOUTH 17TH STREET, PHILADELPHIA, PA, 19103-4196, US

(73) Assignee: Zaxxon USA, Inc.

(21) Appl. No.: 11/036,941

(22) Filed: Jan. 14, 2005

(51) Int. Cl. H01B 1/12

(52) U.S. Cl. 252/500

(57) ABSTRACT

An interior building surface covering that has an ion producing material embedded in surface of covering in contact with the building air. The ion producing material continually releases ionic particles in the air from the interior building surface covering. Without the addition of electricity or other power source, negatively charged ions are emitted into the ambient air. Such generation of negative ions neutralizes or reduces odor, airborne bacteria, mold spores, pollens, and other harmful particles in the air.

### CROSS-REFERENCE TO RELATED APPLICATIONS

NA

### STATEMENTS REGARDING FEDERALLY SPONSORED RESEARCH OR DEVELOPMENT

NA

### REFERENCE TO A MICROFICHE APPENDIX

NA

### BACKGROUND OF THE INVENTION

1. Field of the Invention

Our ambient air is composed of molecules of gases that can become positively or negatively charged, depending on the gain or the loss of an electron due to static electricity discharges and/or natural causes. High concentrations of negatively charged molecules, or negative ions, are often found near waterfalls, country meadows, beaches, and mountains. High concentrations of positively charged molecules, or positive ions, are often found in cities, office buildings, factories and other urban settings.

Scientists now recognize that the concentration of negative ions in the surrounding air has a direct effect on the quality of the air we breathe. Additionally, high levels of negative ions in the air can have the beneficial effect of removing particular contaminants such as pollens, mold spores, smoke, dust particles, airborne germs and bacteria—harmful particles which are, in general, positively charged in nature. The reduction of pollution by negative ions can happen in the following ways 1) by transferring charge to such contaminants, the contaminants are electrostatically attracted to the nearby surfaces that are electrical neutral or oppositely charged and are then deposited against such surfaces; and 2) the removal of pollutants can also happen with the collision between negative ions and pollutants. The negative ions begin small in size and are highly mobile. Their rapid collisions with airborne pollutants cause the ion to lose their mobility. The collisions with these airborne pollutants make them heavy, causing them to fall. This results in cleaner and fresher air.

Air inside buildings tends to become stale and unpleasant to breathe as a result of, in part, the depletion of the negative ion content in the air. Various conventional air ionizers have been developed to counteract the depletion of ions and also to purify air by causing the precipitation of particular contaminants out of the air, and onto nearby surfaces. Such conventional air ionizers typically include pointed electrodes that are connected to high voltage supplies to produce intense electrical fields adjacent the pointed electrodes. Neutral gas molecules in the vicinity of the intense electrical fields are transformed to positive or negative ions, depending upon the polarity of the high voltages on the electrodes. Electrostatic repulsion from the similarly charged electrodes and air blowers disperse the air ions throughout the room to cause precipitation of particular contaminants from the air and to promote the beneficial physiological effects.

While the advanced technologies of ionization have been introduced to ordinary household or healthcare goods and industries such as hairbrushes, footwear, cosmetics, air-conditioners, clothing, water-treatment systems, toilets, hair dryers and other electrical goods, as far as known it has never before been engineered as a property embedded in building materials such as surface covering, and in particular, flooring.

2. Description of the Related Art

Prior to this invention, surface coverings, and in particular, floor-coverings, have born the specialized technical functions of acoustics tolerance, anti-bacterial function, moisture-resistance, conductivity, and anti-static electricity to meet the needs of our contemporary interiors. However, as far as known no flooring has ever been engineered with air-purifying capabilities, or in particular, negative ion-generating capabilities, as a built-in function.

### BRIEF DESCRIPTION OF THE SEVERAL VIEWS OF THE DRAWINGS

FIG. 1 is a cross section of a flooring material with a mixture of natural minerals or ceramic ingredients that continually release ionic particles into the air applied onto or mixed with the coating of the uppermost surface of the flooring material.

FIG. 2 is a cross section of a flooring material with a mixture of natural minerals or ceramic ingredients that continually release ionic particles into the air mixed into the upper stratum of the flooring material.

FIG. 3 is a cross section of a flooring material with a mixture of natural minerals or ceramic ingredients that continually release ionic particles into the air applied under the upper stratum of the flooring material.

### DETAILED DESCRIPTION OF THE INVENTION

This invention concerns a floor surface covering that has air-purifying properties, in particular, a surface covering that has the capability of generating negative ions continuously into the air without the use of electrodes or electricity. As a person walks on the surface covering, the highly mobile negative ions are moved and circulated. As a result, the room increases in overall negative ions and converts atoms in the air into negatively charged ions. The use of ions to purify air in a room is well known as shown in U.S. Pat. Nos. 3,973,927 and 6,610,127.

This present invention has a structurally, mechanically, and molecularly built-in function in flooring of generating optimal levels of negative ions directly and indirectly into the ambient air continually, without the use of electricity or electrodes. The count of negative ions released is ranges from 100 ions/cc to 640 ions cc, with the average count at 400 ions/cc. This generation of negative ions neutralizes or reduces odor, airborne bacteria and germs, mold spores, pollens, allergens and other contaminants or harmful particles in the air. At the same time, it also enhances the overall function of the human respiratory system.

The floor covering (which may be a tile, sheet, plank or strip floor tiles, sheets, or planks, including floor tiles, sheets, and planks or sections of varying sizes and shapes and surface types including those made from polyvinyl chloride, rubber, linoleum, polymeric resins, reinforced resins, vinyl composite, or other resilient materials, carpet, stones, ceramic, metals, glass, textiles, wood, composites thereof in desired combinations, veneers thereof in desired combinations, and laminates thereof in desired combinations) is embedded, mechanically within one millimeter thickness from its upper surface layer in contact with air, with an ion releasing material which naturally release ionic particles in stationary state and at room temperature. Such energy is produced without the addition of pressure, heat, or power or chemical catalyst to activate the ionizing process. The embedding of ionic releasing material is accomplished by applying the material as a coating or by mixing the material into the flooring material layer during the formation of the flooring material layer, or by applying the material directly onto the back of the flooring material layer. To generate the emission of negative ions into the ambient air the depth of the embodiment should generally not exceed one millimeter from the uppermost surface layer of the surface covering in contact with air. An example of ion implantation in a plastic material is shown in U.S. Pat. Nos. 4,526,832, and 4,743,493.

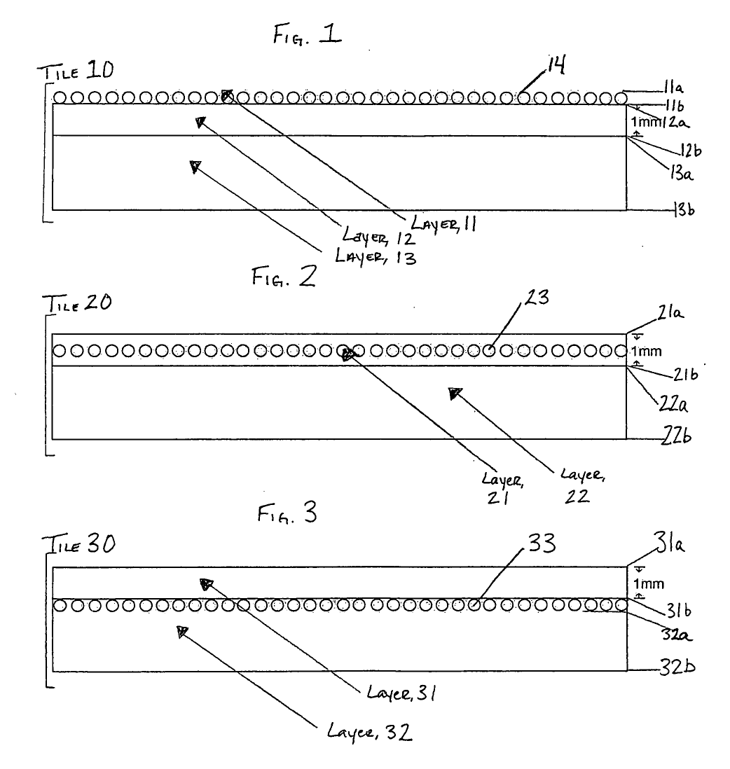

One embodiment of the flooring material comprises the mixture of naturally ionized minerals or ceramic ingredients that continually release ionic particles in the air with the uppermost layer of a floor tile, or mixing such mixture with the coating of the uppermost surface of a floor tile in shown in FIG. 1. FIG. 1 shows an example of application of a mixture of an ion releasing material which could comprise natural minerals or ceramic ingredients in the form of an ionic material 14 that continually releases ionic particles into the air. The flooring material can take the form of a tile 10 with the ionic material applied and can be comprised of multiple layers such as the three layers 11, 12, and 13. This method of application includes the applying of the ionic material 14 onto or mixed with a coating on the top layer 12b of the flooring material. Multiple layer floor tiles are well known as shown in U.S. Pat. No. 6,751,917.

Another embodiment may have the mixture of naturally ionized minerals or ceramic ingredients to be mixed throughout the flooring raw material in an extruded flooring material of homogeneous composition, although such an embodiment yields a less cost-effective version of the invention.

Ionic minerals are comprised of atoms or collections of atoms that retain their intrinsic electric charge, either positive or negative. This electrical charge exists surrounding the atom because it is either missing an electron or has additional electrons within its surrounding area. The addition or subtraction of electrons gives the atom, or ion, its electrical signature, or charge. This charge causes the ions to interact, attracting or repelling each other in a search for another ion to contribute or remove additional electrons, in a never-ending process to create a neutral electrical charge, which is important in maintaining the total concentration of ions in the body.

Various minerals, in their atomic form, link with other minerals to form ionic complexes. Nature has designed an intricate fit between atoms of different species. For instance, each atom has a particular number of electrons within its grasp that it constantly maintains. As this atom interacts with other atoms of the same type, or even different types, it enters into electron-sharing agreements with these different atoms, forming different mineral complexes. This association is highly important to the workings of all biological organisms, as the linking of many different types of atoms forms solid matter.

The ionic effect is not believed to be effected by the size of the ion material. Rather it depends on the ionic charge that is imparted by the material. The density of the ion particles per square centimeter is in the range of about 100 ions/cc to 650 ions/cc. This is based cost analysis versus noticeable impact of product performance. The optimal depth for ionic effect and cost-effective production would be around 1 mm or less from the air-contact top surface. Within this range, the ionic effect has a higher ratio between numbers of ions present and the ionic effect. If the depth exceeds significantly from this range, the ionic effect detected is reduced. The depth depends on the type of ion particle. The ion effect should be long lasting because ions continue to be released because the material is by nature, radioactive. The expected life span of the ion material should the life of the flooring.

Any natural mineral bearing an ionic charge (there are more than 70 types found in nature), especially those found in volcanic ash or natural hot springs should provide ion release in flooring. There are some ceramic ingredients that are found to emit ionic charges naturally as well.

Some examples of the type of minerals used in the ionic composite are Tourmaline, Serpentine and Zeolite. Optimum resonant materials (“ORM”) comprised of a mixture of Tourmaline, Serpentine and other minerals may be used together to emit an ideal level of negative ions. The ionic material could include the ionic releasing minerals (1) lava, (2) volcanic ash, and (3) certain pottery soil/raw ceramic ingredients that emit sufficient ions. Tourmaline is known to emit negative ions and far-infrared rays which is claimed to reduce water clustering and have anti-bacterial and deodorant qualities. Serpentine also is also known to emit negative ions and far infrared waves. It is also an effective deodorant and anti-bacterial agent. The minerals are typically refined into particles of 0.3 microns on average.

The effectiveness of the minerals are believed to be in part due to the size of the ORM particles whereby tourmaline, serpentine and other ionic minerals are refined to 0.3 microns or less. The smaller particles create a greater surface area which increases the minerals' effectiveness.

The effects of negatively charged fresh air are claimed to include (1) improved sense of well being; (2) increased rate and quality of growth in plants and animals; (3) improved function of the lungs protective cilia; (4) tranquilization and relaxation (decreased anxiety); (5) lowered body temperature; (6) lowered resting heart rate; (7) decreased survival of bacteria and viruses in the air; (8) improved learning in mammals; and (9) decreased severity of stomach ulcers

Negatively charged air used to treat dust allergies, pollen (grass, weed and tree pollen) allergies, dust mite allergies, animal dander allergies, mold spores, hay fever, asthma, air purification, odor reduction, smoke elimination, seasonal affective disorder, depression, chronic fatigue.

The type of coating that could be used to protect and retain the ion particles when the ion particles are positioned on the top surface of the wear layer could be a common variety of coating used in flooring materials including urethane coating and UV coating. The ionic particles are mixed in with the coating itself, but are not positioned on top of the coating.

When the ion particles are positioned on the bottom surface of the wear layer, the ionic material could be reversed coated onto the back of the wearlayer, or mixed in the printing ink (if a decorative printed layer is employed as a layer directly beneath the wearlayer). The coating used on top of the flooring can be the common variety of coating used in most flooring material.

The construction of a multiple layer tile is known to those skilled in the tile making art. Examples of multilayer floor tiles are shown in U.S. Pat. Nos. 3,666,521, 4,172,169, 4,418,109.

The thickness of layer 12 defined by the upper surface 12a and the lower surface 12b, should generally not be greater than one millimeter in depth. The ionizing process of emitting negatively charged ions into the ambient air is believed to be optimized if this depth is not greater than one millimeter. Layers 12 and 13 comprise the flooring material to which the ionic material, 14, is applied.

With the ionic material applied to the flooring material, tile 10, the uppermost surface of 10 is 11a and is exposed to the ambient air. The lower surface 11b of the ionic material 14 is adhered to the uppermost surface 12a of layer 12. The bottommost surface 12b of layer 12 is adheres to the uppermost surface 13a of layer 13. The bottommost layer 13 of tile 10 is layer 13 with a bottommost surface 13b.

A second method of application is accomplished by embedding an ion emitting mixture of natural minerals or ceramic ingredients in the uppermost layer 21 of the example tile shown in FIG. 2. The embedded mixture continually releases ionic particles in the air above the top stratum of the flooring material. FIG. 2 displays an example of application whereby the ionic material, 23, is mixed into the uppermost layer 21 of the flooring material of tile 20. Tile 20 is comprised of an upper layer 21 and a lower layer 22.

The embodiment of FIG. 2 is formed by mixing the ionic material 23, into the uppermost layer 21 of the flooring material during the making of the tile. The thickness of the uppermost layer 21 defined by the upper surface 21a and the lower surface 21b should generally not be greater than one millimeter in depth. Layers 21 and 22 comprise the flooring material to which the ionic material, 23, is applied. With the ionic material applied to the flooring material, 20, the uppermost surface of 20 is 21a. Lower surface 21b adheres to the uppermost surface of layer 22 which is 22a. The bottommost layer of 20 is layer 22 with a bottommost surface 22b.

A third embodiment is shown in FIG. 3. This embodiment is made by applying the mixture of natural minerals or ceramic ingredients that continually release ionic particles in the air under the top layer of the flooring material.

FIG. 3 displays tile 30 whereby the ionic material 33 is positioned under the uppermost layer 31 of the flooring material adjacent the bottommost surface 31b of layer 31. The ionic material 33 is positioned between the bottommost surface 31b of layer 31 and the uppermost surface 32a of layer 32.

For optimal effect, the thickness of the layer 31 defined by the top surface 31a and bottom surface 31b should not generally be greater than one millimeter in depth. Layers 31 and 32 comprise the flooring material which is positioned onto a floor surface.

The flooring of the current invention has health-enhancing capabilities including physiological reductions in irritability, depression, sensitivity, and tenseness. The flooring of the current invention further has the built-in capabilities of reducing allergens, moles, odors, contaminants, germs or other positively charged molecules in ambient air.

For purposes of the present invention, surface covering includes, but is not limited, flooring such as resilient floors, vinyl composition tiles, in-aid floors, hardwood floors, vinyl composition tiles, resilient tiles, solid vinyl tiles, printed laminated vinyl tiles, linoleum, rubber, homogeneous floors, cushioned floors, and the like; wall paper; laminates; and countertops. The flooring may be a tile, sheet, plank or strip floor tiles, sheets, or planks, including floor tiles, sheets, and planks or sections of varying sizes and shapes and surface types including those made from polyvinyl chloride, rubber, linoleum, polymeric resins, reinforced resins, vinyl composite, or other resilient materials, carpet, stones, ceramic, metals, glass, textiles, wood, composites thereof in desired combinations, veneers thereof in desired combinations, and laminates thereof in desired combinations.

While the concept is described as being used on floor tiles, sheets and planks it could be used on other floor coverings and coverings for walls, ceilings, countertops and other building material or interior surface-covering material. The air-purifying function is provided by to the placement of natural minerals, synthetic compounds, or ceramic ingredients that release, trigger, or impart ionic charges into the surrounding ambient air naturally, in stationery state and at room temperature. The embedding of the material may take place within any part of the flooring or surface covering, not just the uppermost stratum, also as the ionic charges are imparted into the surrounding air. Accordingly, it is understood that the 1 mm placement on the depth of ion-embedding is only an indication of the optimal level of effect and may be varied depending on the type of material that being used.

While the concept is described as the releasing of the ionic particles, any added natural or synthetic compound or element that releases, imparts or triggers an ionic charge or particles by itself, without additional factors or added electricity, could be used. Many types of natural mineral, synthetic compound, or artificial compound or ceramic ingredients that naturally release, impart or induce ionic charge in ambient air could be used within the covering material.

Although the foregoing specific details describe various embodiments of the invention, persons reasonably skilled in the art will recognize that various changes may be made in the details of the apparatus of this invention without departing from the spirit and scope of the invention as defined in the appended claims. Therefore, it should be understood that, unless otherwise specified, this invention is not to be limited to the specific details shown and described herein.

I claim:

1. An interior building surface covering comprising;
an interior surface covering material having upper and lower surfaces; and
an ion producing material which naturally releases ionic particles at said upper surface into the building interior to provide air-purifying.

2. The interior building surface covering of claim 1, wherein the covering is a floor covering.

3. The interior building surface covering of claim 1, wherein the covering is a wall covering.

4. The interior building surface covering of claim 1, wherein the covering is a ceiling covering.

5. The interior building surface covering of claim 1, wherein the density of the ion particles per square centimeter is in the range of about 100 ions/cc to 650 ions/cc.

6. The interior building surface covering of claim 1, wherein the optimal depth for ionic effect and cost-effective production would be around 1 mm or less from the air-contact top surface.

7. The interior building surface covering of claim 1, where the ion producing material is not greater than about one millimeter from the surface in contact with the air.

8. The surface covering of claim 1, wherein the ion producing material is a mixture of natural minerals and ceramic ingredients.

9. A method providing air purifying to an interior building room comprising the steps of:
applying an interior building surface covering to the interior building room that has an ion producing material in it; and
continually releasing ionic particles from the ion producing material in the air in the interior building room to purify the air.

10. The method of claim 9 wherein the interior building surface covering is applied to the interior floor of the building.

11. The method of claim 9 wherein the interior building surface covering is applied to the interior wall of the building.

12. The method of claim 9 wherein the interior building surface covering is applied to the interior ceiling of the building.

13. The method of claim 9, wherein the ion producing material is positioned not greater than about one millimeter from the surface in contact with the air.

14. The method of claim 9, wherein the interior building surface has a density of the ion particles per square centimeter is in the range of about 100 ions/cc to 650 ions/cc.
